(19) United States
(12) Patent Application Publication
(10) Pub. No.: US 2015/0143957 A1
(43) Pub. Date: May 28, 2015

(54) WATCH WINDER CASE

(71) Applicant: Gooten Innolife Corporation, Taichung City (TW)

(72) Inventors: Yi-Wei LIAO, Taichung City (TW); Shang-Yi LIU, Taichung City (TW)

(73) Assignee: Gooten Innolife Corporation, Taichung City (TW)

(21) Appl. No.: 14/089,159

(22) Filed: Nov. 25, 2013

(51) Int. Cl. G04D 7/00

(52) U.S. Cl. CPC G04D 7/009
USPC 81/7.5

(57) ABSTRACT

A watch winder case is disclosed to include two opposite end plates connected to each other through two first support bars and two second support bars. Two first side plates are respectively abutted and inserted between one of the two first support bars and one of the two second support bars, and a second side plate is abutted and inserted between the two second support bars. Thus, the structural strength and structural stability of the watch winder case can be enhanced.

### BACKGROUND OF THE INVENTION

1. Field of the Invention

The present invention relates generally to a watch winder and more particularly, to a watch winder case that has improved structural stability.

2. Description of the Related Art

A mechanical watch can be a manually winding type, whose mainspring must be wound through a small knob manually to provide energy to run the watch, or an automatically winding type, whose mainspring is wound automatically by the natural motion of the wearer's arm. If the wearer won't wear the watch for a long time, the watch shall be stored in a watch winder that can simulate the aforesaid natural motion to keep the watch operating.

A conventional case for use in the watch winder is typically made of plywood sheets for reducing the weight and manufacturing cost of the watch winder case. However, the plywood case has a weak structure and therefore it may become deformed or get damaged easily after used for long periods of time.

Therefore, it is desirable to provide an improved case for the watch winder that eliminates the aforesaid drawbacks.

### SUMMARY OF THE INVENTION

It is one objective of the present invention to provide a watch winder case, which has improved structural strength and enhanced structural stability.

To achieve this objective of the present invention, the watch winder case comprises two opposite end plates, two symmetrical first support bars connected between the two end plates and each having a first abutment portion and a first insertion portion, and two symmetrical second support bars connected between the two end plates and each having two symmetrical second abutment portions and two symmetrical second insertion portions. One of the two second abutment portions of one of the two second support bars is corresponding to one of the two second abutment portions of the other one of the two second support bars, and the other one of the two second abutment portions of the one of the two second support bars is corresponding to the first abutment portion of one of the two first support bars. Further, one of the two second insertion portions of one of the two second support bars is corresponding to one of the two second insertion portions of the other one of the two second support bars, and the other one of the two second insertion portions of the one of the two second support bars is corresponding to the first insertion portion of the one of the two first support bars.

Further, a side plate set is provided to include two first side plates each abutted against the first abutment portion of one of the two first support bars and one of the two second abutment portions of one of the two second support bars and inserted between the first insertion portion of the one of the two first support bars and one of the two second insertion portions of the one of the two second support bars. A second side plate is abutted against the two second abutment portions of the two second support bars and inserted between the two second insertion portions of the two second support bars.

Preferably, a face plate is mounted between the two first support bars and provided with an accommodating cavity for accommodation of a watch. Further, a transparent door plate is disposed to face the face plate and hingedly connected to a border portion of one of the two first support bars in order to provide protection for the face plate.

Preferably, each of the first abutment portions of each of the two first support bars has a first planar surface and a first inclined surface, and each of the two second abutment portions of each of the two second support bars is provided with a second planar surface and a second inclined surface. One of the first planar surfaces of one of the first support bars is abutted against an inner surface of one of the two first side plates and the other one of the first planar surfaces of the one of the first support bars is abutted against an inner surface of the third side plate, and one of the first inclined surfaces of one of the first support bars is abutted against one of two end bevel edges of one of the two first side plates and the other one of the first inclined surfaces of the one of the first support bars is abutted against one of two end bevel edges of the third side plate. Further, one of the two second planar surfaces of one of the second support bars is abutted against the inner surface of the one of the two first side plates and the other one of the two second planar surfaces of the one of the second support bars is abutted against an inner surface of the second side plate, and one of the two second inclined surfaces of one of the second support bars is abutted against the other one of the two end bevel edges of the one of the two first side plates and the other one of the two second inclined surfaces of the one of the second support bars is abutted against one of two end bevel edges of the second side plate. By this way, the side plate set is easy to be assembled and has enhanced structural stability.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of the watch winder case according to a first embodiment of the present invention;

FIG. 2 is a partially exploded view of the watch winder case according to the first embodiment of the present invention;

FIG. 3 is a top view of a part of the watch winder case according to the first embodiment of the present invention, showing the relationship among the first support bar, the second support bar, and the first side plate;

FIG. 4 is similar to FIG. 3, but showing the relationship between the second support bars and the second side plate;

FIG. 5 is a perspective view of a watch winder case according to a second embodiment of the present invention;

FIG. 6 is a front view of a part of the watch winder case according to the second embodiment of the present invention, showing the relationship among the first support bar, the second support bar, and the first side plate;

FIG. 7 is similar to FIG. 6, but showing the relationship between the second support bars and the second side plate; and

FIG. 8 is similar to FIG. 6, but showing the relationship between the first support bars and the third side plate.

### DETAILED DESCRIPTION OF THE INVENTION

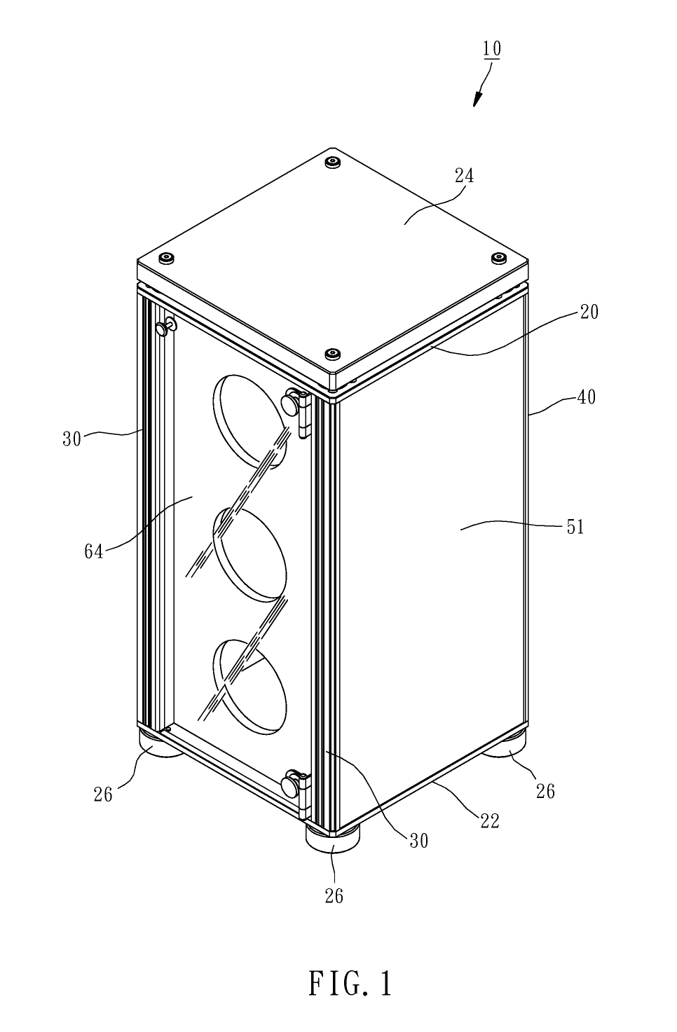

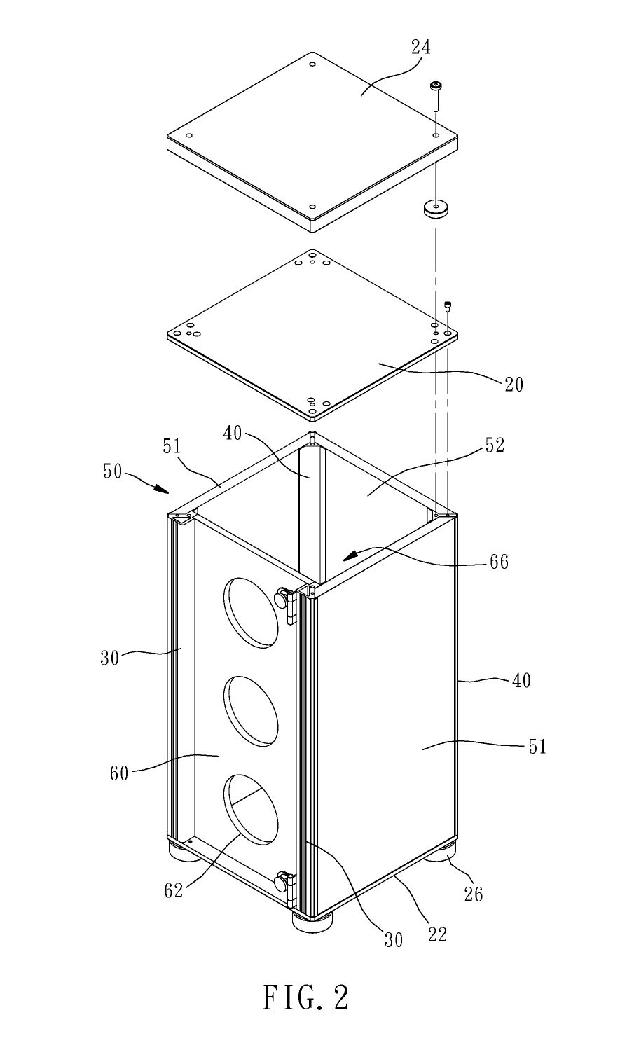

As shown in FIGS. 1 and 2, a watch winder case 10 in accordance with a first embodiment of the present invention comprises two end plates 20 and 22, two first support bars 30, two second support bars 40, and a side plate set 50.

The two end plates 20 and 22 are made of metal and spacedly arranged in an up-down direction. Preferably, the top surface of the end plate 20 can be equipped with a transparent trim plate 24 for raising the quality of the watch winder case 10, and the bottom surface of the end plate 22 can be equipped with four pads 26 to keep the end plate 22 located above a support, such as ground or table.

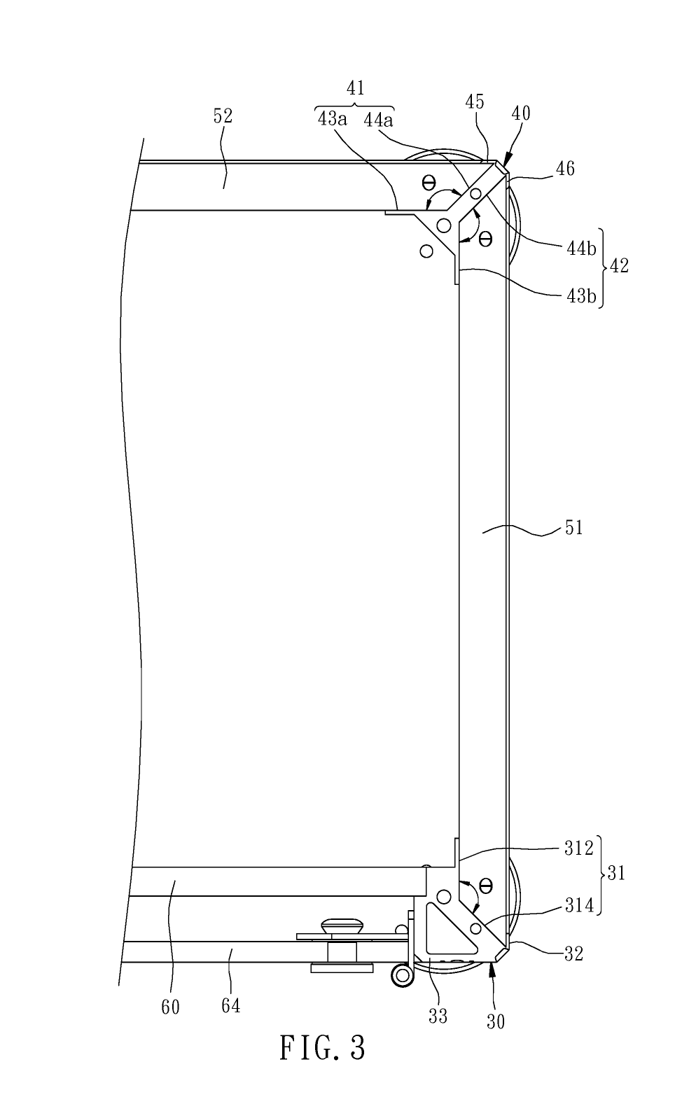

The two first support bars 30 are made from aluminum extrusions and connected between the two end plates 20 and 22 in a symmetrical manner. As shown in FIG. 3, the first support bars 30 each have a first abutment portion 31 with a first planar surface 312 and a first inclined surface 314 adjoined with the first planar surface 312 to define a predetermined angle θ of 135 degrees therebetween. Further, the first support bars 30 each have a first insertion portion 32 adjoined with the first inclined surface 314 of the first abutment portion 31 and an L-shaped border portion 33 located on the back of the first abutment portion 31. As shown in FIG. 2, a face plate 60 is connected between the two first support bars 30 and provided with three accommodating cavities 62, such that a watch (not shown) can be stored in one of the accommodating cavities 62.

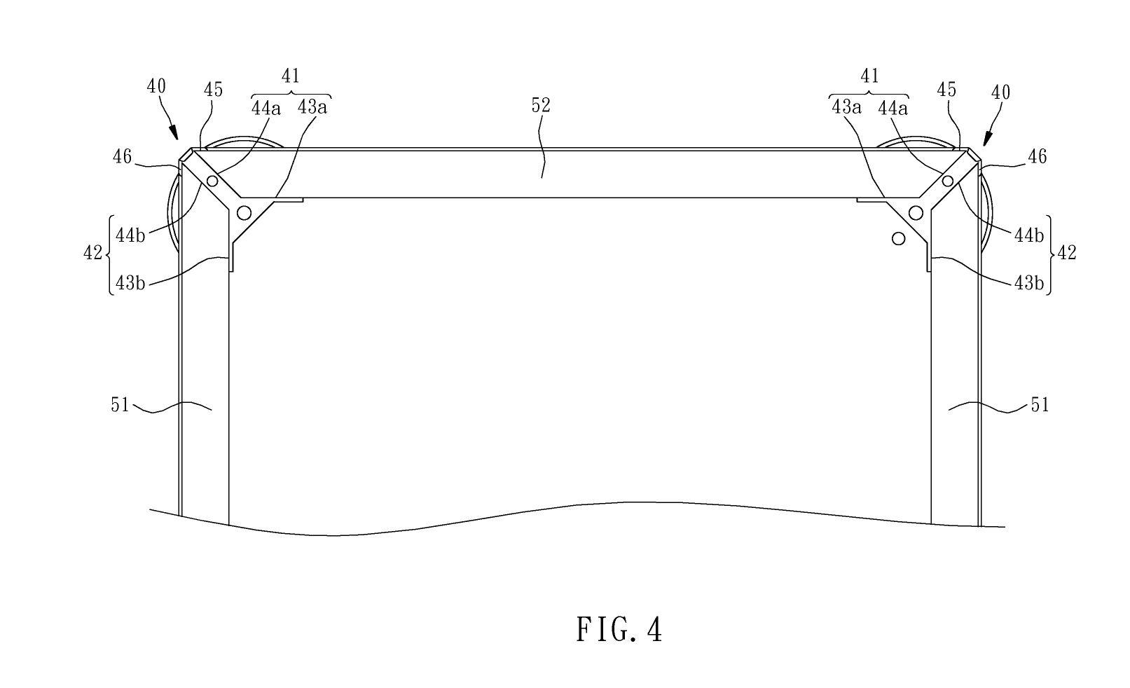

The two second support bars 40 are made from aluminum extrusions and symmetrically connected between the two end plates 20 and 22. As shown in FIGS. 3 and 4, the second support bars 40 each have two symmetrical abutment portions 41 and 42. The second abutment portion 41 of one of the two second support bars 40 is corresponding to the second abutment portion 41 of the other one of the two second support bars 40, and the second abutment portion 42 of one of the two second support bars 40 is corresponding to the first abutment portion 31 of one of the two first support bars 30 and the second abutment portion 42 of the other one of the two second support bars 40 is corresponding to the first abutment portion 31 of the other one of the two first support bars 30. Further, the abutment portion 41 has a second planar surface 43a and a second inclined surface 44a adjoined with the second planar surface 43a to define a predetermined angle θ of 135 degrees therebetween, and furthermore, the second abutment portion 42 has a second planar surface 43b and a second inclined surface 44b adjoined with the second planar surface 43b to define a predetermined angle θ of 135 degrees therebetween. In addition, the second support bars 40 each have two symmetrical second insertion portions 45 and 46. The second insertion portion 45 of one of the two second support bars 40 is corresponding to the second insertion portion 45 of the other one of the two second support bars 40, and the second insertion portion 46 of one of the two second support bars 40 is corresponding to the first insertion portion 32 of one of the two first support bars 30 and the second insertion portion 46 of the other one of the two second support bars 40 is corresponding to the first insertion portion 32 of the other one of the two first support bars 30.

The side plate set 50 includes two first side plates 51. As shown in FIGS. 3 and 4, each of the two first side plates 51 is inserted between the first insertion portion 32 of one of the two first support bars 30 and the second insertion portion 46 of one of the two second support bars 40; moreover, the inner surface of the first side plate 51 is abutted against the first planar surface 312 of the first abutment portion 31 of the first support bar 30 and the second planar surface 43b of the second abutment portion 42 of the second support bar 40, and the two end bevel edges of the first side plate 51 are abutted against the first inclined surface 314 of the first abutment portion 31 of the first support bar 30 and the second inclined surface 44b of the second abutment portion 42 of the second support bar 40, respectively. In addition, the side plate set 50 further includes a second side plate 52 inserted between the second insertion portions 45 of the two second support bars 40, and furthermore, the inner surface of the second side plate 52 is abutted against the second planar surfaces 43a of the second abutment portions 41 of the two second support bars 40, and the two end bevel edges of the second side plate 52 are abutted against the second inclined surfaces 44a of the second abutment portions 41 of the two second support bars 40, respectively.

After the watch winder case 10 is assembled, a chamber 66 is defined by the two end plates 20 and 22, the face plate 60, and the side plate set 50 for installation of a winding unit (not shown), such that the watch stored in the accommodation cavity 62 can be kept running by the winding unit. Besides, as shown in FIGS. 1 and 3, a transparent door plate 64 is provided facing the face plate 60 and hingedly connected to the L-shaped border portion 33 of one of the two first support bars 30 for protecting face plate 60 and the watches.

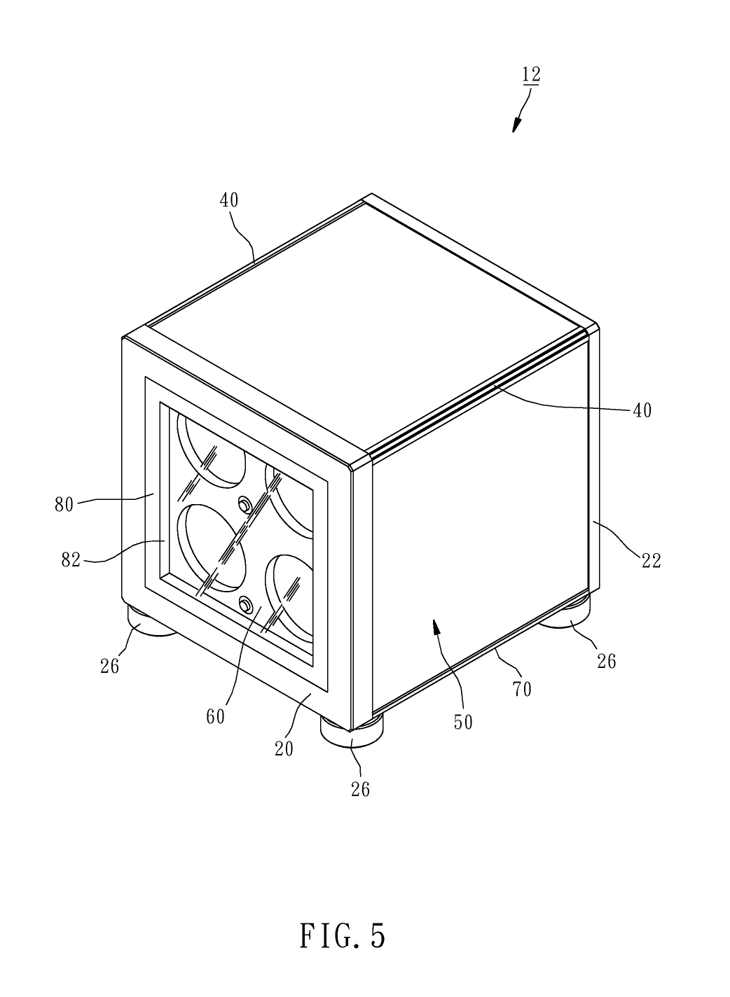

On the other hand, the watch winder case can be made with different kinds of design on the basis of the spirit of the present invention. For example, as shown in FIG. 5, a watch winder case 12 according to a second embodiment of the present invention comprises two end plates 20 and 22, two first support bars 70, two second support bars 40, and a side plate set 50.

The two end plates 20 and 22 are made of metal and arranged in a front-back direction. Further, the outer surface of the end plate 20 is equipped with the face plate 60, and the bottom side of each of the two end plates 20 and 22 is equipped with two pads 26 to keep the two end plates 22 and 24 located above the ground or the table.

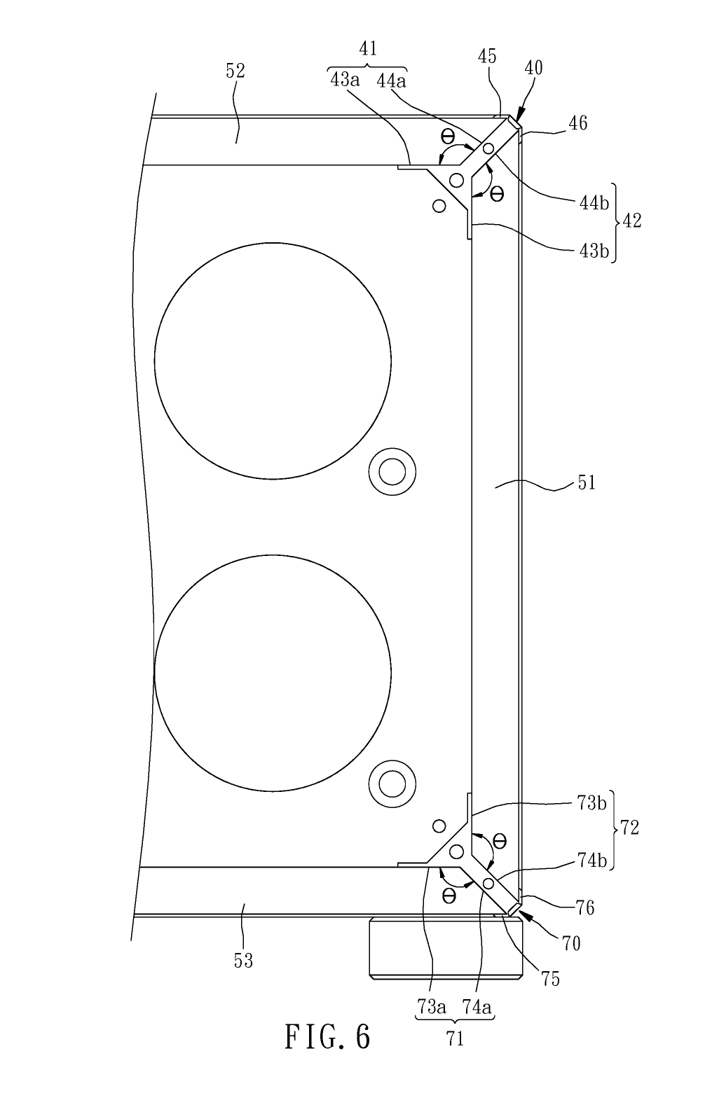

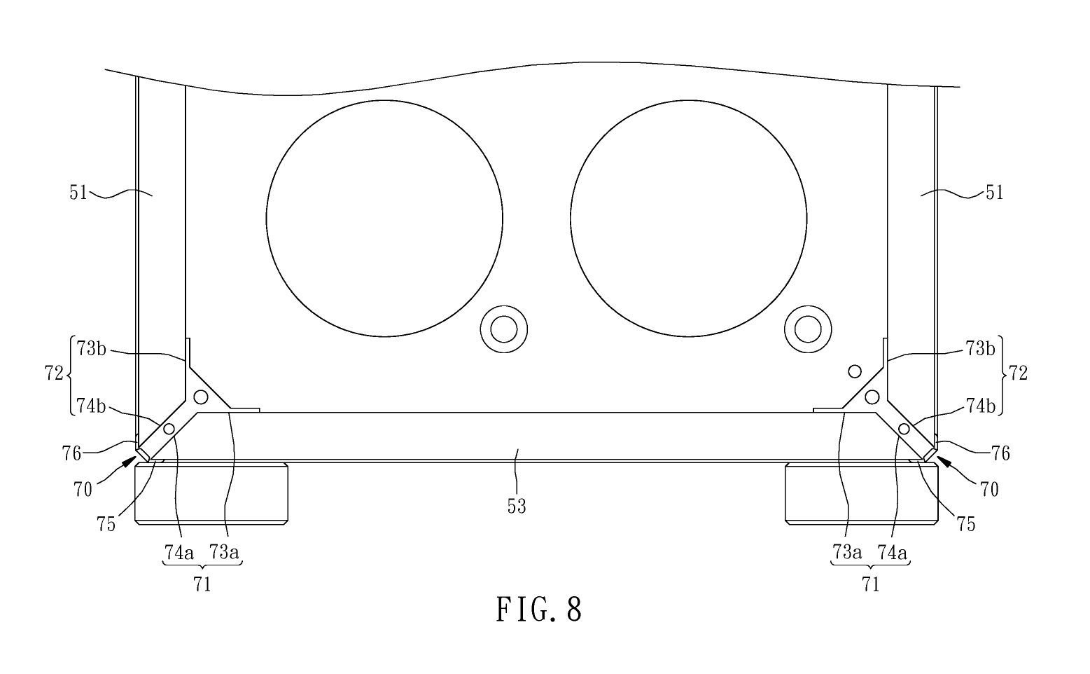

The two first support bars 70 are made from aluminum extrusions and connected between the two end plates 20 and 22 in a symmetrical manner. As shown in FIGS. 6 and 8, the first support bars 70 each have two symmetrical first abutment portions 71 and 72 and two symmetrical first insertion portions 75 and 76. The first abutment portion 71 has a first planar surface 73a and a first inclined surface 74a adjoined with the first planar surface 73a to define a predetermined angle θ of 135 degrees therebetween, and furthermore, the first abutment portion 72 has a first planar surface 73b and a first inclined surface 74b adjoined with the first planar surface 73b to define a predetermined angle θ of 135 degrees therebetween.

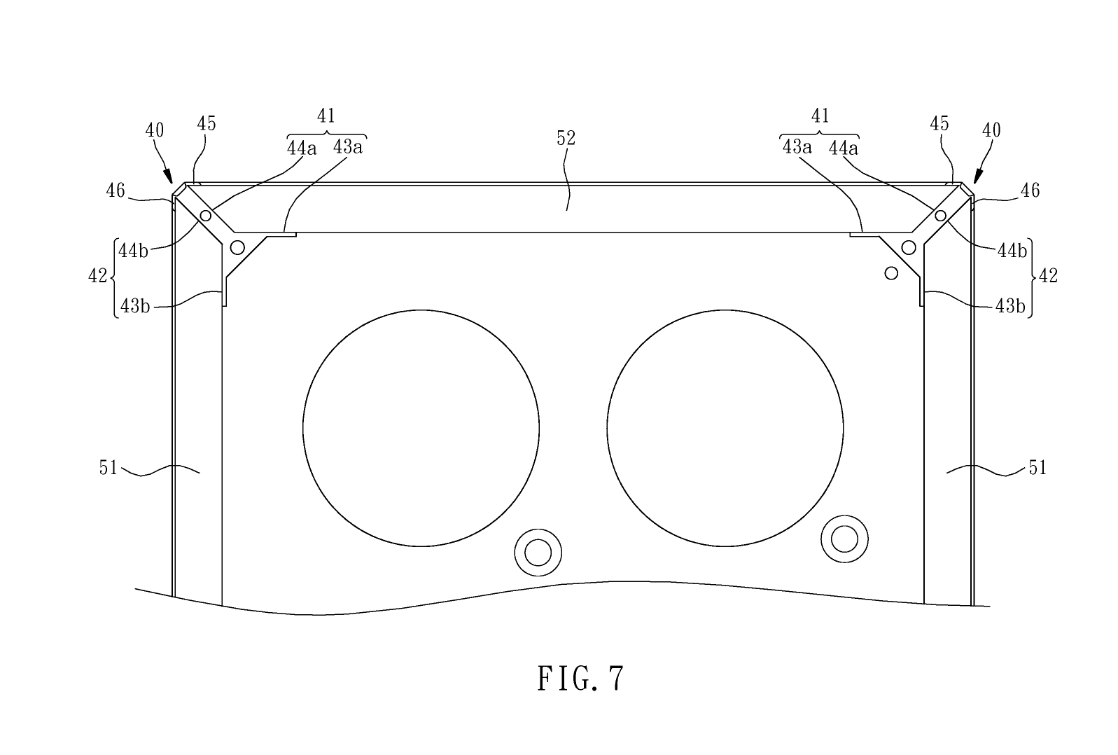

The two second support bars 40 are made from aluminum extrusions and symmetrically connected between the two end plates 20 and 22. As shown in FIGS. 6 and 7, the second support bars 40 each have two symmetrical second abutment portions 41 and 42. The second abutment portion 41 of one of the two second support bars 40 is corresponding to the second abutment portion 41 of the other one of the two second support bars 40, and the second abutment portion 42 of one of the two second support bars 40 is corresponding to the first abutment portion 72 of one of the two first support bars 70 and the second abutment portion 42 of the other one of the two second support bars 40 is corresponding to the first abutment portion 72 of the other one of the two first support bars 70. Further, the second abutment portion 41 has a second planar surface 43a and a second inclined surface 44a adjoined with the second planar surface 43a to define a predetermined angle θ of 135 degrees therebetween, and furthermore, the second abutment portion 42 has a second planar surface 43b and a second inclined surface 44b adjoined with the second planar surface 43b to define a predetermined angle θ of 135 degrees therebetween. In addition, the second support bars 40 each have two symmetrical second insertion portions 45 and 46. The second insertion portion 45 of one of the two second support bars 40 is corresponding to the second insertion portion 45 of the other one of the two second support bars 40, and the second insertion portion 46 of one of the two second support bars 40 is corresponding to the first insertion portion 76 of one of the two first support bars 70 and the second insertion portion 46 of the other one of the two second support bars 40 is corresponding to the first insertion portion 76 of the other one of the two first support bars 70.

The side plate set 50 includes two first side plates 51, a second side plate 52 and a third side plate 53. As shown in FIG. 6, each of the two first side plates 51 is inserted between the first insertion portion 76 of one of the two first support bars 70 and the second insertion portion 46 of one of the two second support bars 40; moreover, the inner surface of the first side plate 51 is abutted against the first planar surface 73b of the first abutment portion 72 of the first support bar 70 and the second planar surface 43b of the second abutment portion 42 of the second support bar 40, and furthermore, the two end bevel edges of the first side plate 51 are abutted against the first inclined surface 74b of the first abutment portion 72 of the first support bar 70 and the second inclined surface 44b of the second abutment portion 42 of the second support bar 40. In addition, the second side plate 52 is inserted between the second insertion portions 45 of the two second support bars 40. As shown in FIG. 7, the inner surface of the second side plate 52 is abutted against the second planar surfaces 43a of the second abutment portions 41 of the two second support bars 40, and the two end bevel edges of the second side plate 52 are abutted against the second inclined surfaces 44a of the second abutment portions 41 of the two second support bars 40. Further, the third side plate 52 is inserted between the first insertion portions 75 of the two first support bars 40. As shown in FIG. 8, the inner surface of the third side plate 53 is abutted against the first planar surfaces 73a of the first abutment portions 71 of the two first support bars 70, and the two end bevel edges of the third side plate 53 are abutted against the first inclined surfaces 74a of the first abutment portions 71 of the two first support bars 70.

After the watch winder case 12 is assembled, a chamber (not shown) is defined by the two end plates 20 and 22, the face plate 60, and the side plate set 50 for installation of the winding unit (not shown), such that the watches can be kept operating by the winding unit. Besides, as shown in FIG. 5, a doorframe 80 is hingedly connected to one lateral side of the end plate 20 and a transparent door plate 82 is retained in the doorframe 80 for protecting the watches and the face plate 60.

As indicative above, the present invention uses four bars to provide structural support for other components, such as the two opposite end plates, the side plate set, the face plate, and the transparent door plate. Compared with the plywood case of the conventional watch winder, the present invention has higher structural strength and greater structural stability to reduce the risk of deformation and damage, such that the watch stored in the watch winder case of the present invention can be displayed in a desired manner.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A watch winder case comprising:
two end plates;
two first support bars spacedly connected between the two end plates and each having a first abutment portion and a first insertion portion;
two second support bars spacedly connected between the two end plates and each having two symmetrical second abutment portions and two symmetrical second insertion portions, one of the two second abutment portions of one of the two second support bars being corresponding to one of the two second abutment portions of the other one of the two second support bars, and the other one of the two second abutment portions of the one of the two second support bars being corresponding to the first abutment portion of one of the two first support bars, one of the two second insertion portions of one of the two second support bars being corresponding to one of the two second insertion portions of the other one of the two second support bars, and the other one of the two second insertion portions of the one of the two second support bars being corresponding to the first insertion portion of the one of the two first support bars; and
a side plate set including two first side plates each abutted against the first abutment portion of one of the two first support bars and one of the two second abutment portions of one of the two second support bars and inserted between the first insertion portion of the one of the two first support bars and one of the two second insertion portions of the one of the two second support bars, and a second side plate abutted against the two second abutment portions of the two second support bars and inserted between the two second insertion portions of the two second support bars.

2. The watch winder case as claimed in claim 1, further comprising a face plate connected between the two first support bars and provided with an accommodating cavity.

3. The watch winder case as claimed in claim 2, further comprising a transparent door plate facing the face plate and hingedly connected to a border portion of one of the two first support bars.

4. The watch winder case as claimed in claim 3, wherein the first abutment portion of each of the two first support bars is provided with a first planar surface abutted against an inner surface of one of the two first side plates and a first inclined surface abutted against one of two end bevel edges of one of the two first side plates, and each of the two second abutment portions of each of the two second support bars is provided with a second planar surface and a second inclined surface; one of the two second planar surfaces of one of the two second support bars is abutted against the inner surface of one of the two first side plates and the other one of the two second planar surfaces of the one of the second support bars is abutted against an inner surface of the second side plate, and one of the two second inclined surfaces of one of the two second support bars is abutted against the other one of the two end bevel edges of the one of the two first side plates and the other one of the two second inclined surfaces of one of the two second support bars is abutted against one of two end bevel edges of the second side plate.

5. The watch winder case as claimed in claim 4, wherein an angle defined between the first planar surface and the first inclined surface is 135 degrees, and an angle defined between the second planar surface and the second inclined surface is 135 degrees.

6. The watch winder case as claimed in claim 5, wherein a plurality of pads are provided at a bottom surface of one of the two end plates.

7. The watch winder case as claimed in claim 1, further comprising a face plate connected to an outer surface of one of the two end plates and provided with an accommodating cavity.

8. The watch winder case as claimed in claim 7, further comprising a doorframe hingedly connected to one of the two end plates and a transparent door plate retained in the doorframe and facing the face plate.

9. The watch winder case as claimed in claim 7, wherein the number of the first abutment portion of each of the two first support bars is two, and the number of the first insertion portion of each of the two first support bars is two; the side plate set further includes a third side plate abutted against the two first abutment portions of the two first support bars and inserted between the two first insertion portions of the two first support bars.

10. The watch winder case as claimed in claim 9, wherein each of the first abutment portions of each of the two first support bars is provided with a first planar surface and a first inclined surface, and each of the two second abutment portions of each of the two second support bars is provided with a second planar surface and a second inclined surface; one of the first planar surfaces of one of the first support bars is abutted against an inner surface of one of the two first side plates and the other one of the first planar surfaces of the one of the first support bars is abutted against an inner surface of the third side plate, and one of the first inclined surfaces of one of the first support bars is abutted against one of two end bevel edges of one of the two first side plates and the other one of the first inclined surfaces of the one of the first support bars is abutted against one of two end bevel edges of the third side plate; one of the two second planar surfaces of one of the second support bars is abutted against the inner surface of the one of the two first side plates and the other one of the two second planar surfaces of the one of the second support bars is abutted against an inner surface of the second side plate, and one of the two second inclined surfaces of one of the second support bars is abutted against the other one of the two end bevel edges of the one of the two first side plates and the other one of the two second inclined surfaces of the one of the second support bars is abutted against one of two end bevel edges of the second side plate.

11. The watch winder case as claimed in claim 10, wherein an angle defined between the first planar surface and the first inclined surface is 135 degrees, and an angle defined between the second planar surface and the second inclined surface is 135 degrees.

12. The watch winder case as claimed in claim 11, wherein a plurality of pads are provided at a bottom surface of each of the end plates.
